(19) United States
(12) Patent Application Publication
(10) Pub. No.: US 2014/0164930 A1
(43) Pub. Date: Jun. 12, 2014

(54) MOBILE DEVICE APPLICATION FOR REMOTELY CONTROLLING A PRESENTATION ACCESSED VIA A PRESENTATION SERVER

(71) Applicant: CLEARSIDE, INC., San Francisco, CA (US)

(72) Inventors: Adam Michael Lieb, San Francisco, CA (US); Stefano Acerbetti, San Francisco, CA (US)

(73) Assignee: Clearside, Inc., San Francisco, CA (US)

(21) Appl. No.: 13/842,201

(22) Filed: Mar. 15, 2013

Related U.S. Application Data
(60) Provisional application No. 61/736,512, filed on Dec. 12, 2012.

(51) Int. Cl. H04L 29/06

(52) U.S. Cl. CPC H04L 65/403
USPC 715/730

(57) ABSTRACT

An exemplary method comprises providing authentication information from a user of a mobile computing device to the presentation server; causing the presentation server to provide a view of a presentation to a viewer device via a viewer link, wherein the presentation is stored on the presentation server; providing a remote control interface for the user to enter a user input, wherein the remote control interface is to occupy a display of the mobile computing device; and controlling the view of the presentation in response to the user input. Among other benefits, some embodiments provided herein provides both the benefit of performing a live presentation over a network to one or more viewers and the convenience of controlling the live presentation using a presenter's mobile device (e.g., a smart phone) that a traditional remote presentation controller can bring.

### CROSS-REFERENCE TO RELATED APPLICATIONS

This application claims priority to and the benefit of U.S. Provisional Application No. 61/736,512, entitled “MOBILE DEVICE APPLICATION FOR REMOTELY CONTROLLING A PRESENTATION ACCESSED VIA A PRESENTATION SERVER”, filed Dec. 12, 2012, which is incorporated by reference herein.

### COPYRIGHT NOTICE

A portion of the disclosure of this patent document contains material that is subject to copyright protection. The copyright owner has no objection to the facsimile reproduction by anyone of the patent document or the patent disclosure, as it appears in the United States Patent and Trademark Office patent files or records, but otherwise reserves all copyright rights whatsoever. The following notice applies to the software and data as described below and in the drawings that form a part of this document: Copyright 2013, ClearSlide, Inc., All Rights Reserved.

### TECHNICAL FIELD

The present disclosure relates to computerized presentation of sales and/or other information, and more specifically, to remotely controlling a computerized presentation accessed via a presentation server over a communications network (e.g., the Internet).

### BACKGROUND

Typically, computerized presentation (e.g., a Powerpoint presentation) requires a presentation file to be stored on a local computer and requires particular software (e.g., Microsoft Powerpoint) compatible with the presentation file to be installed on the computer in order to display the presentation properly. This process generally needs to be performed ahead of time at a location where the computer is physically located before any presentation can be made.

It is useful for a presenter to be able to perform a live presentation over a network to one or more viewers. However, existing solutions which provide this type of functionality have several limitations. The presenter must normally download and install software (such as executables or plugins) to his or her computer in order to share the presentation remotely over the network. The viewers must also complete a time-consuming setup process, which can include software downloads and an email-based invitation setup process to connect the viewers to the presenter. These limitations prevent the use of these solutions in certain situations, such as a cold sales call or a sales pitch, where it is desirable to reduce any intervening set-up time as much as possible.

### BRIEF DESCRIPTION OF DRAWINGS

The present embodiments are illustrated by way of example and are not intended to be limited by the figures of the accompanying drawings. In the drawings:

FIG. 1A depicts a diagram of an exemplary environment where a presentation server provides delivery of a stored presentation over a network, such as the Internet, as controlled by a presenter's mobile device;

FIG. 1B depicts a simplified functional diagram of the presenter's mobile computing device of FIG. 1A with an mobile device application installed on the device in accordance with some embodiments;

FIG. 2 depicts an exemplary screenshot of a login screen which can gather authentication information from a user;

FIG. 3 depicts an exemplary screenshot that displays information about a viewer link for a user to disseminate to one or more viewers after the user logs into the presentation server via a mobile device application;

FIG. 4 depicts an exemplary remote control interface for controlling the view of the presentation in response to the user input;

FIG. 5 depicts an exemplary screenshot of the presentation selection screen for the user to select a presentation from a plurality of the presentations stored on the presentation server;

FIG. 6 depicts an exemplary screenshot of the slide selection/preview interface for the user to select a slide from the presentation selected in FIG. 5;

FIG. 7 depicts additional or alternative control interfaces and/or mechanisms which may be adopted for the user to control the presentation;

FIG. 8 depicts an exemplary screenshot of an option menu;

FIG. 9 depicts an exemplary screenshot of the settings that the presenter user can modify;

FIG. 10 depicts an exemplary screenshot of a screen that allows the presenter to turn the access code on or off;

FIG. 11 depicts an exemplary screenshot of a pitch recap screen;

FIG. 12A depicts a flowchart illustrating an example process of controlling a presentation accessed via a presentation server from a mobile device;

FIG. 12B depicts a flowchart illustrating an additional or an alternative example process of controlling a presentation accessed via a presentation server from a mobile device; and

FIG. 13 depicts a block diagram showing an example of the architecture for a system in which the present embodiments may be implemented.

The same reference numbers and any acronyms identify elements or acts with the same or similar structure or functionality throughout the drawings and specification for ease of understanding and convenience.

### DETAILED DESCRIPTION

Techniques are disclosed for remotely controlling a presentation accessed via a presentation server using a mobile device application. An exemplary method comprises providing authentication information from a user of a mobile computing device to the presentation server; causing the presentation server to provide a view of a presentation to a viewer device via a viewer link, wherein the presentation is stored on the presentation server; providing a remote control interface for the user to enter a user input, wherein the remote control interface is to occupy a display of the mobile computing device; and controlling the view of the presentation in response to the user input. Among other benefits, some embodiments disclosed herein provide both the benefit of performing a live presentation over a network to one or more viewers and the convenience of controlling the live presentation using a presenter's mobile device (e.g., a smart phone) that a traditional remote presentation controller can bring.

Various examples of the present disclosure will now be described. The following description provides specific details for a thorough understanding and enabling description of these examples. One skilled in the relevant art will understand, however, that the embodiments disclosed herein may be practiced without many of these details. Likewise, one skilled in the relevant art will also understand that the present embodiments may include many other obvious features not described in detail herein. Additionally, some well-known methods, procedures, structures or functions may not be shown or described in detail below, so as to avoid unnecessarily obscuring the relevant description.

The techniques disclosed below are to be interpreted in their broadest reasonable manner, even though they are being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

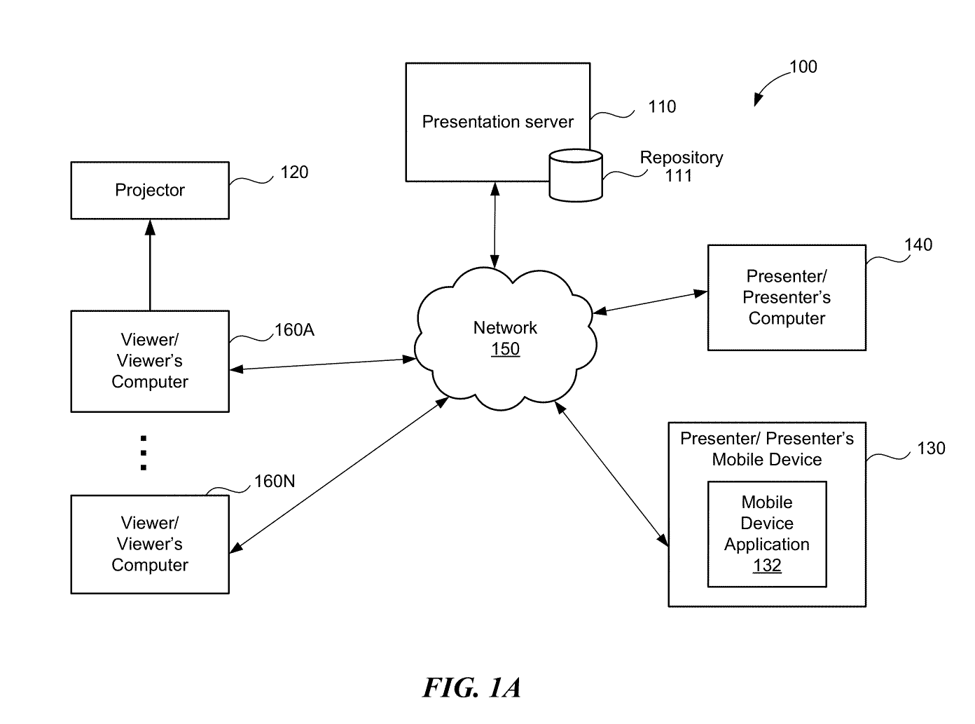

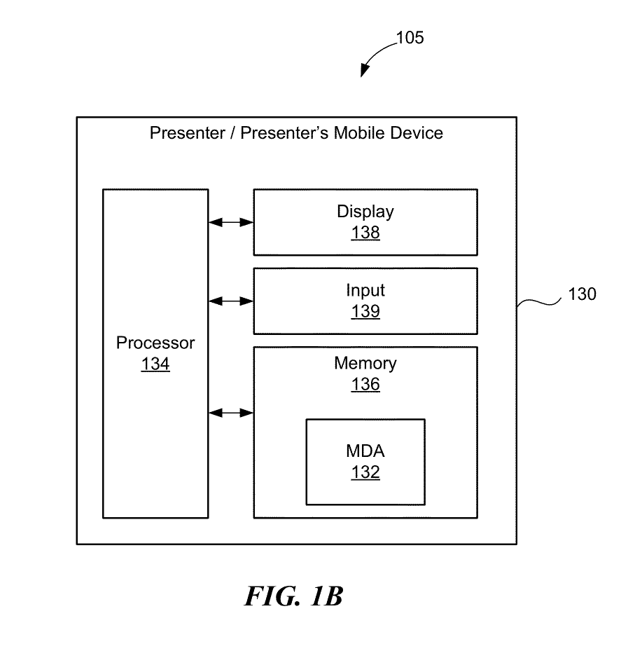

FIG. 1A depicts a diagram of an exemplary environment 100 where a presentation server 110 provides delivery of a stored presentation in a repository 111 over a network 150, such as the Internet, to one or more viewers 160A-160N. The environment 100 includes a presenter operating a presenter computer 140 and/or a presenter mobile computing device (MCD) 130, one or more viewers operating viewer devices 160A-160N, a presentation server 110, and a network 150.

The MCD 130, the presenter device 140 and the viewer devices 160A-160N can be any system and/or device, and/or any combination of devices/systems that is able to establish a connection, including wired, wireless, cellular connections with another device, a server and/or other systems such as presentation server 110. The MCD 130, viewer devices 160 and presenter device 140 typically include a display and/or other output functionalities to present information and data exchanged between or among the devices 130, 140, 160 and/or the presentation server 110. In one embodiment, there is only a single presentation server 110. In one embodiment, there are multiple presentation servers 110 operating independently.

The viewer devices 160 and the presenter device 140 may include general computing devices and may be any of, but not limited to, a server desktop, a desktop computer, a computer cluster, a notebook, or a laptop computer. The MCD 130 may include mobile, hand held, or portable devices, and may be any of, but not limited to, a handheld computer, a palmtop computer, a mobile phone, a cell phone, a smart phone, a PDA, a Blackberry device, a Treo, a handheld tablet (e.g., an iPad, a Galaxy, Xoom Tablet, etc.), a tablet PC, a thin-client device, a hand held console, a hand held gaming device or console, an iPhone, and/or any other portable, mobile, hand held devices, etc. In one example, the MCD 130, the viewer devices 160, presentation server 110, and presenter's device 140 are coupled via the network 150. In some other examples, the devices 130, 140, 160 and presentation server 110 may be directly connected to one another.

FIG. 1B depicts a simplified functional diagram 105 of the presenter's mobile computing device 130 of FIG. 1A with a mobile device application (MDA) 132 installed on the device 130 in accordance with some embodiments. The device 130 includes a processor component 134, a memory component 136, a display screen 138, and one or more input mechanisms 139.

Memory component 136 can be any suitable memory element or device including, for example, DRAM, SRAM, ROM, EEPROM and/or Flash memory. Processor component 134 can be any suitable processor capable of executing scripts or instructions of one or more software programs stored, for example, in memory component 136. Although not shown in FIG. 1B for simplicity, MCD 130 can also include a well-known cache memory that stores frequently used instructions and/or data.

The display screen 138 may include one or more display monitors suitable for displaying various symbols and information, and may include a touch-screen control layer which would also function as an input mechanism. The input mechanism 139 on MCD 130 can include, but is not limited to, a touch screen keypad (including single touch, multi-touch, gesture sensing in 2D or 3D, etc.), a physical keypad, a keyboard, one or more actuatable buttons, a mouse, a pointer, a track pad, motion detector (e.g., including 1-axis, 2-axis, 3-axis accelerometer, etc.), a light sensor, capacitance sensor, resistance sensor, temperature sensor, proximity sensor, a piezoelectric device, device orientation detector (e.g., electronic compass, tilt sensor, rotation sensor, gyroscope, accelerometer), or a combination of the above.

According to the embodiments of the present disclosure, the delivery of the stored presentation from the presentation server 110 to the viewers 160A-160N is controlled by the presenter's mobile device 130. A presenter 140 can upload a presentation to the presentation server 110 for storage, and then the presenter 140 or any viewer 160A, 160N can access the presentation over the network 150 from any computer that connects to an appropriate web link. Each presentation uploaded is called a “presentation deck,” which may contain one or more slides inside the presentation deck. The slides of the presentation deck can each embed different types of media including, but not limited to, a Powerpoint slide, a live webpage, PDF documents, and videos. The presentation server 110 is described in more detail in U.S. patent application Ser. No. 12/756,110, entitled “MIXED CONTENT TYPE PRESENTATION SYSTEM,” filed Apr. 7, 2010, and is incorporated herein in its entirety.

In one mode, the presenter 140 can send a web link (e.g., via an email) to the presentation stored on the presentation server 110 to one or more recipients 160A, 160N for viewing whenever the recipients want (i.e., not controlled by the presenter 140). The presentation server 110 tracks data related to the recipients' access of the presentation including, but not limited to, when each recipient 160A, 160N views the presentation, how long each recipient 160A, 160N views each slide of the presentation, whether any of the recipients 160A, 160N forwarded the link to the presentation to other viewers, and to whom the link to the presentation was forwarded. Similarly, when subsequent viewers of the presentation access the presentation using the link, the presentation server 110 also tracks viewing data related to subsequent viewers.

In another mode, the presenter can make a “live presentation” to one or more viewers 160A, 160N remotely. The presenter 140 can access his presentation on the presentation server 110 and send a viewer link (e.g., an URL) for the live presentation to one or more viewers 160A, 160N. When those viewers 160A, 160N access the viewer link (e.g., via a web browser) using a client device, they can automatically see the slides (e.g., as provided within the web browser by the presentation server 110) of the presentation as the presenter 140 selects each slide for display. Moreover, the presenter 140 is not limited to the slides from a single presentation. The presenter can select slides from different stored presentations for the live presentation. In the live presentation mode, the presentation server 110 can also track data related to the live pitch, similar to the tracked data for viewers independently viewing a presentation. The analytic data for each presentation, whether delivered as a live presentation or viewed by a viewer independently, is available to the presenter 140 to review through the presentation server 110.

The embodiments disclosed herein recognize that, as aforementioned, it is useful for a presenter to be able to perform a live presentation over a network to one or more viewers. Furthermore, the embodiments disclosed herein recognize that traditional remote presentation controllers for controlling presentation (e.g., flipping forward or backward slides from the presentation) typically need to be first coupled (e.g., via a Bluetooth dongle) to the computer that displays the presentation and properly configured (e.g., installing a driver or setting up related software) before the remote controllers can be used.

Accordingly, in order to minimize intervening set-up time, it is beneficial to provide techniques to enable capabilities of both performing a live presentation over a network to one or more viewers and controlling the live presentation using a presenter's mobile device (e.g., a smart phone) in a way that simulates a traditional remote presentation controller.

In accordance with the embodiments disclosed herein, in situations where the presenter 140 desires to use the live presentation mode to present a presentation to a live audience in the same room or in close proximity, the presenter 140 can further uses the MDA 132 running on the MCD 130 including, for example, a smart phone, a tablet, or a “phablet,” to remotely control the slide presentation during the in-person presentation.

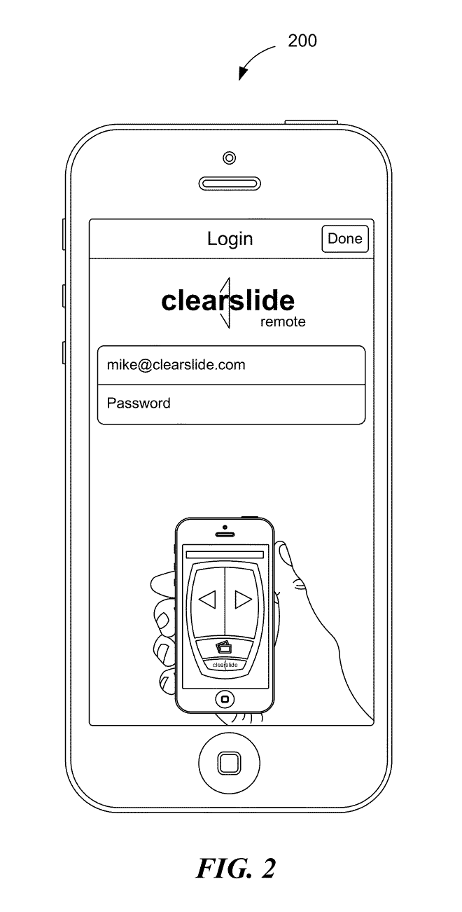

More specifically, in one embodiment, a user (e.g., the presenter 140) starts by logging into the presentation server 110 through the MDA 132 running on the mobile device 130. FIG. 2 shows an example log in screen 200. The MDA 132 requests and verifies authentication information from the presenter 140 (e.g., in forms of a username/password combination), and provides the received authentication information to the presentation server 110. Upon confirmation by the presentation server 110, the presenter 140 can access presentations previously stored at the repository 111 of the presentation server 110 under the user's account.

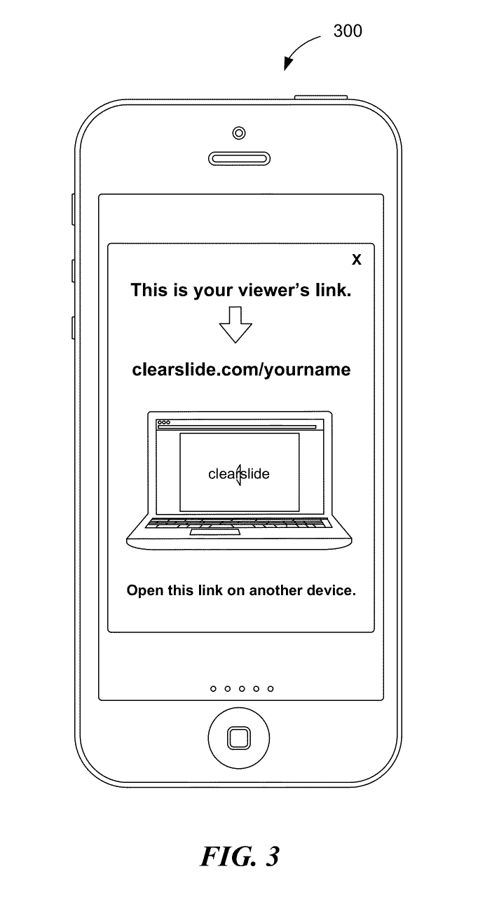

Once the presenter 140 has logged into the presentation server 110, the server 110 provides information about a viewer link, such as shown in the example screenshot 300 of FIG. 3, for the presenter 140 to disseminate to the viewers 160A-160N. For the example that the presenter 140 using the live presentation mode and presenting to the viewers 160A-160N in the same room, the presenter 140 may choose to use the viewer device 160A as a presentation device, which may be coupled to a screen projector 120, so that the presenter 140 as well as one or more live audiences in the same room may see the presentation. In field applications including, for example, a sales pitch, the viewer device 160A may be a piece of computer equipment that is provided by either the sales person, the client, or a third party (e.g., a conference room manager). As previously mentioned, the viewer device 160A has access to the Internet to connect to the viewer link. After the viewer device 160A loads the viewer link into a web browser, the presentation can be viewed by the audiences on the projector 120 while the presenter remotely controls the presentation using the MDA 132 on the mobile device 130.

It is noted that, because the viewer device 160A accesses the presentation through the viewer link without requiring the presenter 140 to log into an account on the presentation server 110, the presentation device 120 is not provided with any controls over the presentation, such as slide selection for display. In the existing solutions, the presenter 140 needs to bring his or her laptop computer to the room (or borrow a computer that is in the room), log in to the presentation server 110 from the computer so that it becomes the presenter device 140, and select the presentation for showing to the audience and thus be provided control over the presentation. Moreover, it is not convenient to control the presentation from a fixed location in the room, for example, next to a keyboard of the presenter device computer 140, and the presenter 140 needs to further bring along his or her remote presentation controller and couple the controller to the computer in order to remotely control the presentation.

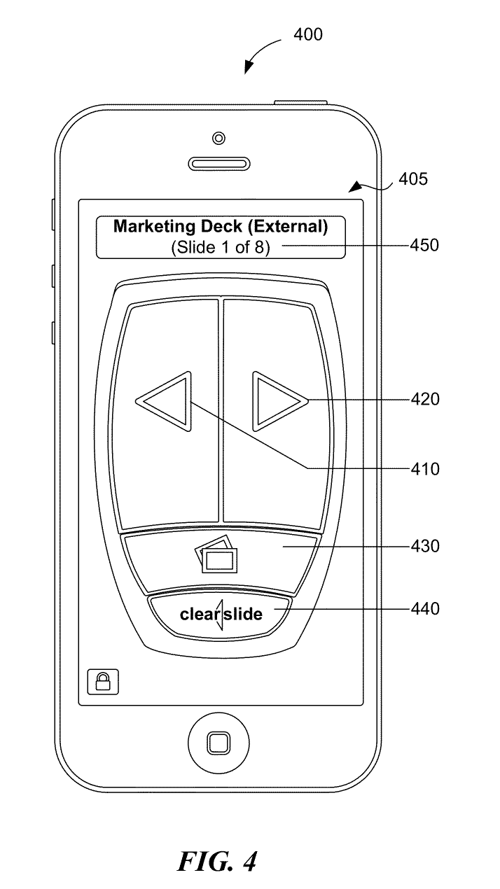

In contrast, the MDA 132 provides a remote controller user interface on the mobile device 130 for use as a remote control for controlling the view of the presentation displayed by the presentation server 110. An example of a first remote control user interface 400 for controlling the view of the presentation in response to the user input is shown in FIG. 4. The interface 400 includes four virtual buttons, a previous button 410, a next button 420, a selection button 430, and a menu button 440. The MDA 132 can detect activation or selection of (e.g., tapping on) a virtual button through the input mechanisms 139 (e.g., a touch screen).

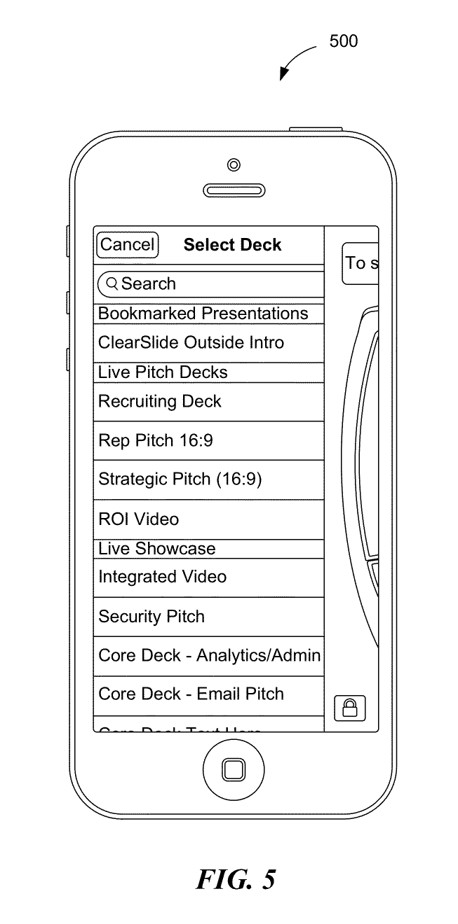

Tapping the selection button 430 allows the presenter 140 to select a presentation deck for the presentation. The MDA 132 accesses the presentations that the presenter 140 has available stored under his or her account (and/or otherwise associated with the presenter 140) on the presentation server 110 and displays them, for example, in a list, on the user interface on the mobile device 130. FIG. 5 shows an example presentation selection screen 500 for the presenter 140. The list can be further categorized by the presenter 140 according to his or her preference. The presenter 140 selects one of the presentations, and the viewer device 160A connected to the viewer link for the presentation automatically shows (e.g., through the projector 120) the first slide of the selected presentation. In some embodiments of the MDA 132, the presentation selection screen 500 is automatically loaded after the presenter 140 logs into the presentation server 110 using the MDA 132. In other embodiments, the presenter 140 may choose a default presentation deck to be loaded once the presenter 140 logs into the presentation server 110, without the need of making a selection in the presentation selection screen 500.

Further, with the first remote control user interface 400, the presenter 140 can tap the virtual previous button 410 on the user interface 400 to display a view of a previous slide in the presentation, or the virtual next button 420 to display a view of a next slide in the presentation. The large buttons on the user interface make it easy for the presenter 140 to find the appropriate button to tap. According to one or more embodiments, the first remote control interface 400 is to occupy the display 138 (e.g., touch-screen 405, FIG. 4) of the MCD 130; in some embodiments, the interface 400 is to occupy the screen 405 so as to preclude any view of the presentation from the screen 405. A top bar 450 in the user interface 400 may identify the slide that is being shown by the presentation device 120.

In this way, without the need of coupling any device to computers and/or setting up any software programs, the disclosed techniques provide a similar user experience of a traditional remote controller in a setting where the presenter 140 is sharing the view with the one or more audiences in the same room using the projector 120.

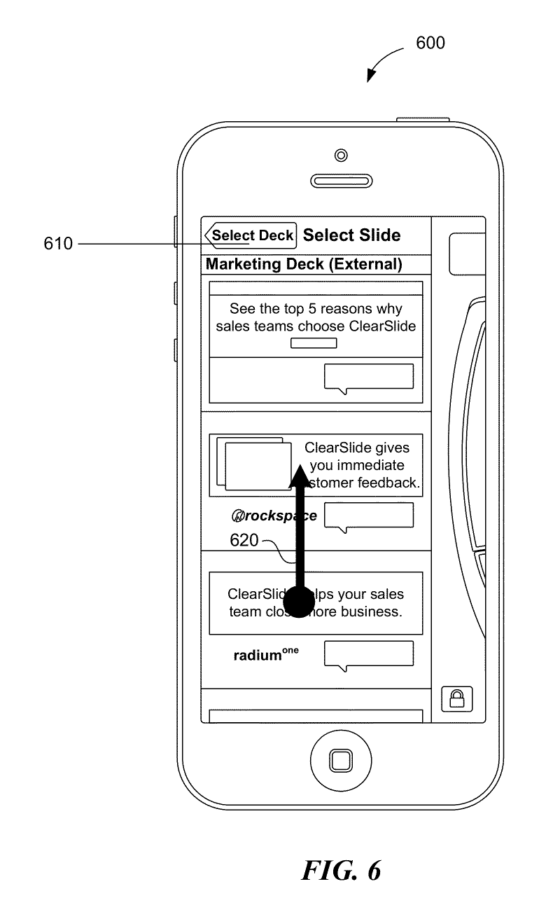

In some instances, the presenter 140 may prefer to preview the slides and select a slide using the preview, rather than using the remote control buttons 410-440 of the example user interface 400 shown in FIG. 4. In some other instances, the presenter 140 may prefer to select a particular slide from the presentation for display or as a start point, rather than the first slide. The MDA 132 provides an option for using a second user interface, such as the slide selection/preview interface 600 of FIG. 6, to show the presenter 140 a preview of the slides of a selected presentation. For example, this user interface 600 shows the slides of a selected presentation (e.g., as a plurality of miniature or thumbnail slides), and the presenter 140 can tap on a particular slide for viewing by the audiences through the projector 120.

In some embodiments of the MDA 132, the slide selection/preview screen is automatically loaded after the presenter 140 selects a presentation deck from the presentation selection screen 500 such as shown in FIG. 5. Moreover, with the user interface 600, the presenter 140 can select a “Select Deck” button 610 shown in the top left corner of the screen to go back to the presentation selection screen 500, which display the presentations that the presenter 140 has available stored under his or her account on the presentation server 110, as described above with regard to FIG. 5. On the interface 600, the presenter 140 can browse through slides using a swiping gesture (e.g., an upward swipe 620 shown in FIG. 6) on the touch-screen of the MCD 130. Then, the presenter 140 selects or jumps to (e.g., by tapping on) a slide from that presentation for viewing through the projector 120, while the viewing audiences only see the selected slides. In some embodiments, the MDA 132 displays the view of the current presentation on the display 138.

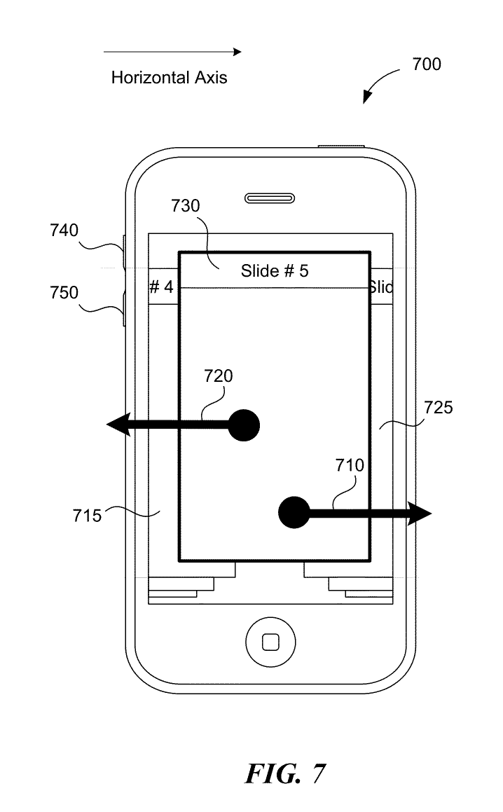

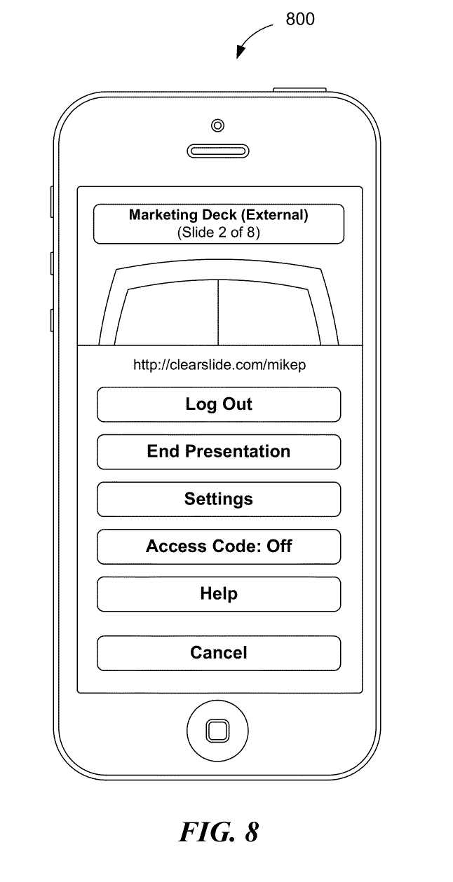

In some additional or alternative embodiments, the MDA 132 provides an option for using a third user interface, such as the slide selection/preview interface 700 of FIG. 7, to show the presenter 140 a preview of the slides of a selected presentation. For example, this user interface 700 shows the slides of a selected presentation (e.g., as a plurality of miniature or thumbnail slides), and the presenter 140 can browse through slides using swiping gestures on the touch-screen of the MCD 130. For example, a right swipe 710 shown in FIG. 7 provides a view of a previous slide 715 of the presentation, and a left swipe 720 shown in FIG. 7 provides a view of a next slide 725 of the presentation. Then, the presenter 140 can tap on a particular slide (e.g., slide 730) for viewing by the audiences through the projector 120. Also, in some embodiments where the input mechanisms 139 includes one or more actuatable buttons such as a volume up button 740 or a volume down button 750, the presenter 140 can control the view of the presentation using these actuatable buttons in a similar way to the swiping gestures. For example, pushing the volume up button 740 may provide a view of the previous slide 715 while pushing the volume down button 750 may provide a view of the next slide 725. Some embodiments provide that if the presenter 140 makes a predetermined swiping gesture (e.g., downward or upward) anywhere on the touch screen, the MDA 132 makes a menu bar (e.g., menu 800, FIG. 8) or a presentation selection screen (e.g., screen 500, FIG. 5) appears.

Continuing with FIG. 4, at any time during or after the presentation, the presenter 140 can access settings for the MDA 132 by tapping the virtual menu button 440 in the user interface 400. Then the MDA 132 provides the presenter 140 with a menu 800 of virtual buttons, as shown in FIG. 8, to select from which trigger corresponding actions, for example, logging out from the presentation server 110, ending the presentation, modifying settings for the MDA 132, changing a setting of the access code, selecting a help menu, or selecting a cancel button that brings the presenter 140 back to the presentation user interface 400.

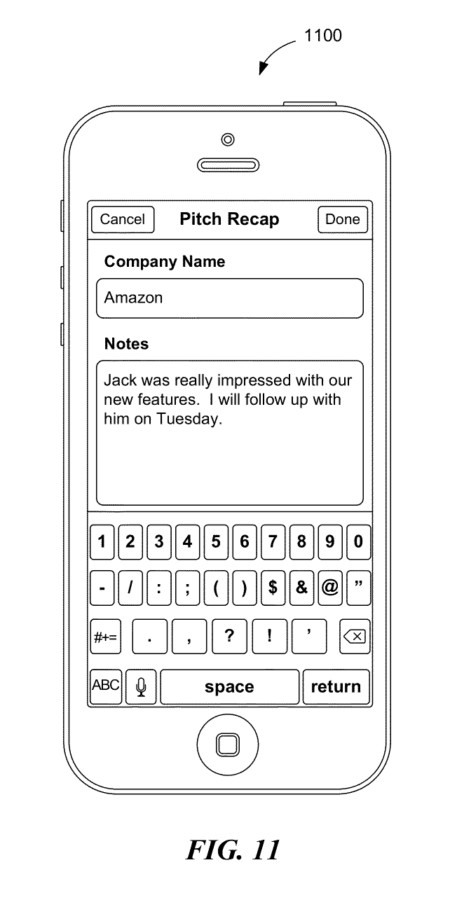

When the presenter 140 selects the log out option, the MDA 132 disconnects the presenter 140 from the presentation server 110. When the presenter 140 selects the end presentation option, the MDA 132 causes the presentation server 110 to stop providing the view of the presentation to viewer devices 160, but does not disconnect the presenter 140 from the presentation server 110. In some embodiments, when the presenter 140 selects the end presentation option, the MDA 132 is triggered to request that the presenter 140 fill out a brief pitch recap, shown in the example screenshot 1100 of FIG. 11. As shown in FIG. 11, the pitch recap prompts the presenter 140 to enter the name(s) of the company and/or audiences that viewed the presentation as well as any notes the presenter wishes to make about the presentation, for example, questions or issues brought up by the audience or action items for follow-up. The information entered by the presenter 140 is uploaded to the presentation server 110 by the MDA 132 at an appropriate time (e.g., which does not interfere with the presentation of the presenter 140).

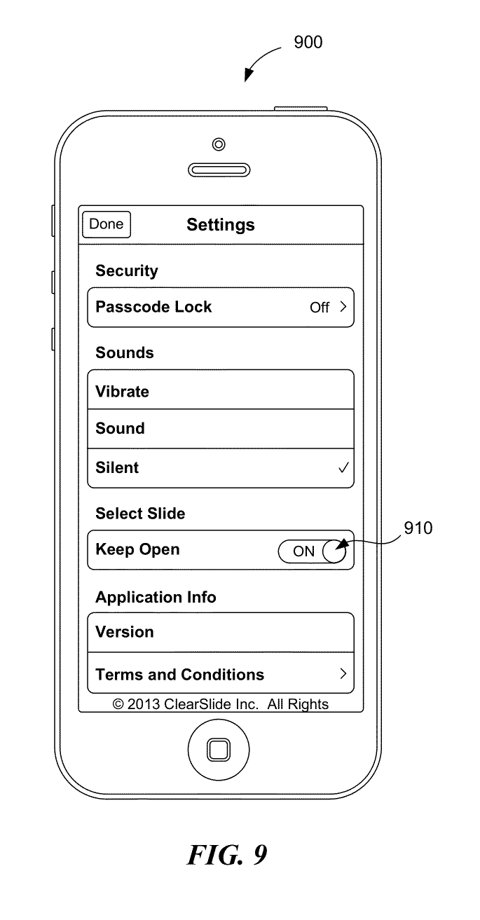

FIG. 9 shows an example screenshot 900 of the settings that the presenter 140 can modify. Setting modifications can include setting the type of feedback the MDA 132 provides upon each tap of a user interface button (e.g., buttons 410-440, FIG. 4). The feedback options include silence where no feedback is given; a sound, such as a beep; and a short vibration or tactile feedback upon selection of a button of the user interface. Feedback allows the presenter 140 to use the remote control interface without having to look at the mobile device and yet knowing that a selected command was sent by the MDA 132.

The presenter 140 can also select a toggle switch 910 in the settings that determines whether to use (e.g., by not returning to the first user interface 400) the second user interface 600 (or the third user interface 700) that displays the preview of the slides when a slide is selected. If the presenter 140 chooses the setting to close the slide, then after the presenter 140 selects a slide, the user interface reverts to the first user interface 400 with the buttons 410-440 as shown, for example, in FIG. 4. Otherwise, the second user interface 600(or the third user interface 700) remains open upon selection of a slide.

The presenter 140 can also turn a passcode lock on or off, as shown in the example screenshot 900 of the settings interface. If the passcode is on, the presenter user 140 must enter a correct passcode to access the MDA 132 on the mobile device 130.

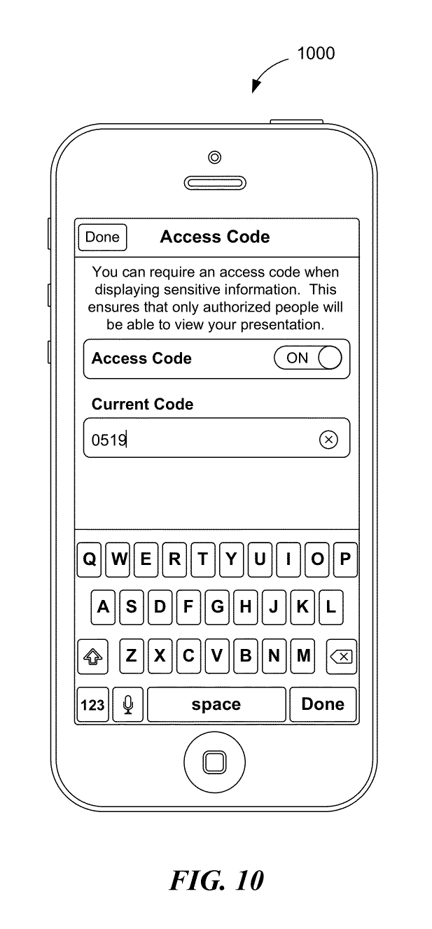

Additionally, under the menu 800 of options, for example, shown in FIG. 8, the presenter 140 can select whether an access code lock for the presentation is on or off. FIG. 10 shows an example screenshot of a screen 1000 that allows the presenter to turn the access code on or off. If the access code lock is set by the presenter 140, then the MDA 132 transmits the access code to the presentation server 140, and the viewer devices 160A-160N must enter the access code in order to connect to or access the viewer link for the presentation.

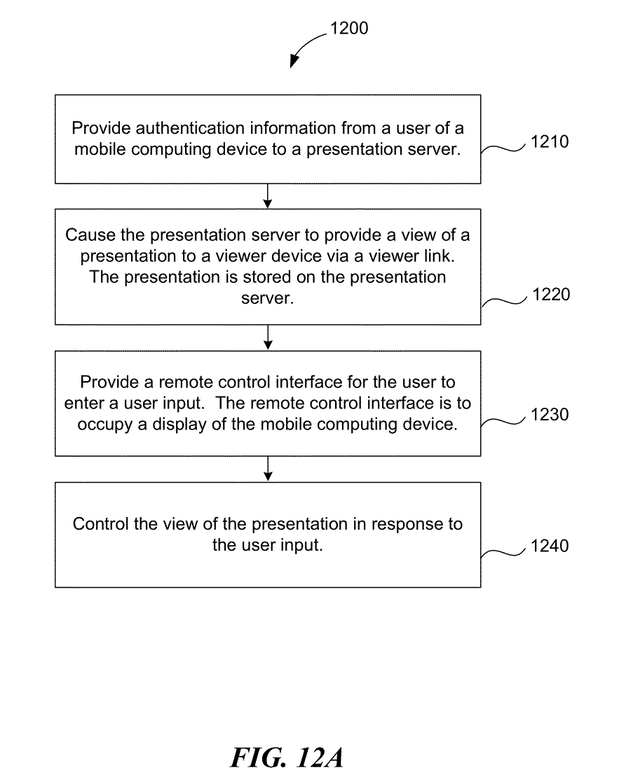

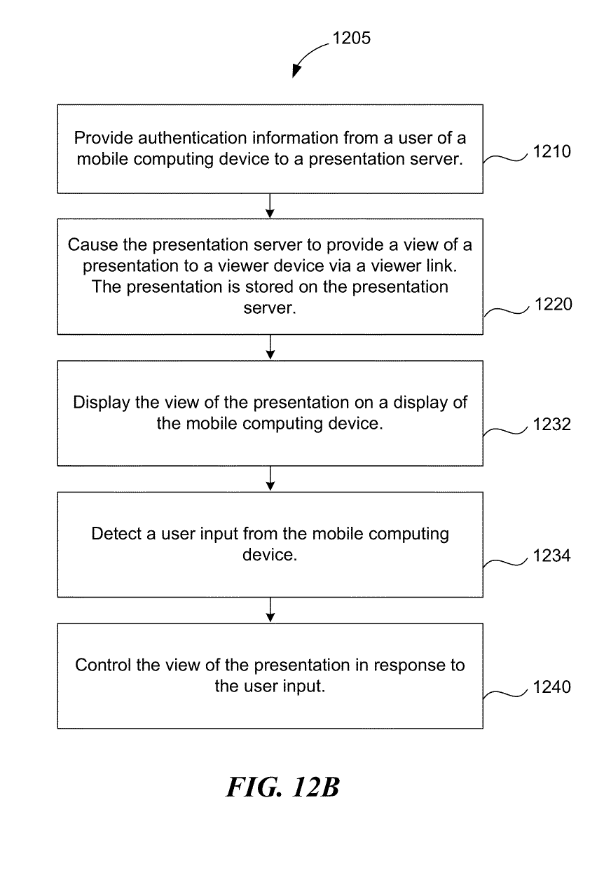

FIG. 12A depicts a flowchart illustrating an example process 1200 of controlling a presentation accessed via a presentation server from a mobile device. For example, a salesman user may want to present a live presentation to audiences in the same conference room the salesman is in, and the presentation is to be presented over a network from a presentation server.

First, with reference to FIGS. 1A-4, the user (e.g., a presenter 140, FIG. 1A) runs an embodiment of an MDA as described above (e.g., MDA 132, FIG. 1A) on his or her smart phone (e.g., MCD 130, FIG. 1A). The MDA 132 asks the presenter 140 for authentication information (e.g., via login screen 200, FIG. 2), and provides (1210) the received authentication information to the presentation server (e.g., server 110, FIG. 1A). Then in some embodiments, after logging in, the MDA 132 receives from the presenter 140 a selection of a presentation from a plurality of presentations associated with the presenter 140 and stored on the presentation server 110. In these embodiments, the MDA 132 may further receive from the presenter 140 a selection of a slide from the presentation, and the view of the presentation starts with the selected slide.

Thereafter, the MDA 132 causes (1220) the presentation server 110 to provide a view of the presentation to one or more viewer devices (e.g., devices 160A-160N) via a viewer link. In some embodiments, the view of the presentation is automatically provided within a browser of the viewer device 160A-160N accessing the viewer link.

Further, the MDA 132 provides (1230) a remote control interface (e.g., interface 400, FIG. 4) for the presenter 140 to enter a user input (e.g., tapping on button 420, FIG. 4). The remote control interface 400 is to occupy a display (e.g., touch-screen 405, FIG. 4) of the MCD 130. Next, the MDA 132 controls (1240) the presentation server 110 in producing the view of the presentation in response to the user input.

FIG. 12B depicts a flowchart illustrating an additional or an alternative example process 1205 of controlling a presentation accessed via a presentation server from a mobile device. With further reference to FIGS. 6-7, process 1205 is similar to process 1200, except that it may be suitable for embodiments that employ an alternative user interface such as the second user interface 600 (FIG. 6) or the third user interface 700 (FIG. 7) as described above. In lieu of step 1230, the MDA 132 displays (1232) the view of the presentation on the display 405 of the MCD 130. Further, the MDA 132 detects (1234) the user input (e.g., swiping gesture 620, FIG. 6, or actuation of button 740, FIG. 7) for controlling the presentation server 110 in producing the view of the presentation

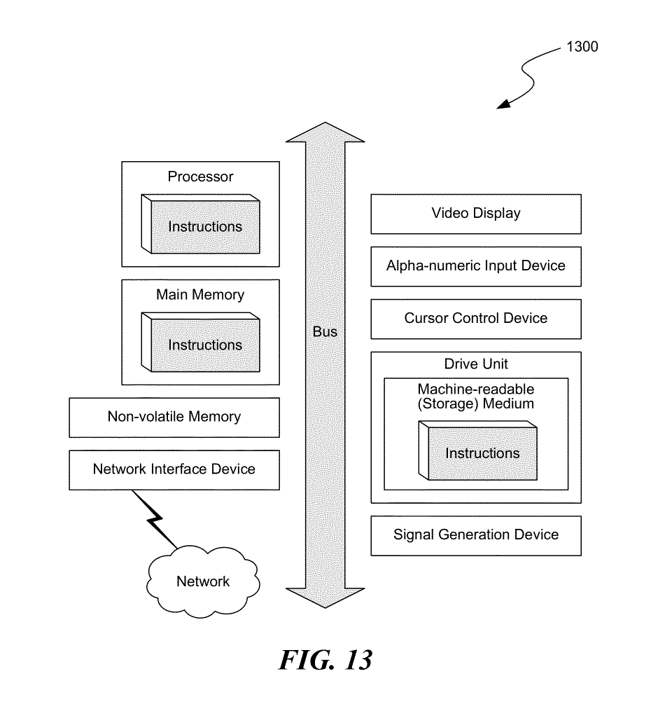

FIG. 13 shows a diagrammatic representation of a machine 1300 in the example form of a mobile computer system within which a set of instructions, for causing the machine to perform any one or more of the methodologies discussed herein, may be executed

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a user device, a tablet PC, a laptop computer, a set-top box (STB), a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The network interface device enables the machine 1300 to mediate data in a network with an entity that is external to the host server, through any known and/or convenient communications protocol supported by the host and the external entity. The network interface device can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device can include a firewall which can, in some embodiments, govern and/or manage permission to access/proxy data in a computer network, and track varying levels of trust between different machines and/or applications. he firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or subcombinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶ 6 will begin with the words “means for.”) Accordingly, the applicant reserves the right to add additional claims after filing the application to pursue such additional claim forms for other aspects of the invention.

What is claimed is:

1. A computer-implemented method for controlling a presentation accessed via a presentation server, the method comprising:
providing authentication information from a user of a mobile computing device to the presentation server;
causing the presentation server to provide a view of a presentation to a viewer device via a viewer link, wherein the presentation is stored on the presentation server;
providing a remote control interface for the user to enter a user input, wherein the remote control interface is to occupy a display of the mobile computing device; and
controlling the view of the presentation in response to the user input.

2. The method of claim 1, wherein the view of the presentation is automatically provided within a browser of the viewer device accessing the viewer link.

3. The method of claim 1, wherein the remote control interface is to occupy the display of the mobile computing device so as to preclude any view of the presentation from the display.

4. The method of claim 1, further comprising:
receiving from the user a selection of the presentation from a plurality of presentations associated with the user and stored on the presentation server.

5. The method of claim 4, further comprising:
receiving from the user a selection of a slide from the presentation, wherein the view of the presentation starts with the selected slide.

6. The method of claim 5, further comprising:
presenting a plurality of thumbnails slides of the presentation to enable the user in selecting the slide.

7. The method of claim 1, further comprising:
receiving an access code from the user; and
transmitting the access code to the presentation server, wherein accessing the viewer link requires the access code.

8. The method of claim 1, wherein the remote control interface includes a first button selectable to provide a view of a next slide of the presentation, and a second button selectable to provide a view of a previous slide of the presentation.

9. The method of claim 8, wherein the remote control interface includes a third button selectable to allow the user to select the presentation.

10. The method of claim 1, wherein the presentation server is coupled to the mobile computing device and to the viewer device via a communications network.

11. The method of claim 10, wherein the mobile computing device includes telephony circuitry that is to transmit and receive data to and from the communications network.

12. The method of claim 10, wherein the communications network comprises the Internet.

13. A mobile device for controlling a presentation accessed via a presentation server, the device comprising:
a processor; and
a memory coupled to the processor and storing a plurality of instructions which, when executed by the processor, cause the processor to:
provide authentication information from a user of a mobile computing device to the presentation server;
instruct the presentation server to provide a view of a presentation to a viewer device via a viewer link, wherein the presentation is stored on the presentation server;
provide a remote control interface for the user to enter a user input, wherein the remote control interface is to occupy a display of the mobile computing device; and
control the view of the presentation in response to the user input.

14. The device of claim 13, wherein the view of the presentation is automatically provided within a browser of the viewer device accessing the viewer link.

15. The device of claim 13, wherein the remote control interface is to occupy the display of the mobile computing device so as to preclude any view of the presentation from the display.

16. The device of claim 13, wherein the instructions further cause the processor to:
receive from the user a selection of the presentation from a plurality of presentations associated with the user and stored on the presentation server.

17. The device of claim 16, wherein the instructions further cause the processor to:
receive from the user a selection of a slide from the presentation, wherein the view of the presentation starts with the selected slide.

18. The device of claim 17, wherein the instructions further cause the processor to:
present a plurality of thumbnails slides of the presentation to enable the user in selecting the slide as the starting point.

19. The device of claim 13, wherein the instructions further cause the processor to:
receive an access code from the user; and
transmit the access code to the presentation server, wherein accessing the viewer link requires the access code.

20. The device of claim 13, wherein the remote control interface includes a first button selectable to provide a view of a next slide of the presentation, a second button selectable to provide a view of a previous slide of the presentation, and a third button selectable to allow the user to select the presentation.

21. The device of claim 13, wherein the presentation server is coupled to the mobile computing device and to the viewer device via a communications network that comprises the Internet.

22. The device of claim 13, wherein the mobile computing device includes telephony circuitry that is to transmit and receive data to and from the communications network.

23. A non-transitory storage medium storing instructions which, when loaded into a memory and executed by a processor of a mobile computing device, cause the processor to:
provide authentication information from a user of the mobile computing device to the presentation server;
instruct the presentation server to provide a view of a presentation to a browser of a viewer device via a viewer link, wherein the presentation is stored on the presentation server;
provide a remote control interface for the user to enter a user input, wherein the remote control interface is to occupy a display of the mobile computing device; and
control the view of the presentation in response to the user input.

24. The medium of claim 23, wherein the remote control interface is to occupy the display of the mobile computing device so as to preclude any view of the presentation from the display.

25. A computer-implemented method for controlling a presentation accessed via a presentation server, the method comprising:
providing authentication information from a user of a mobile computing device to the presentation server;
causing the presentation server to provide a view of a presentation to a viewer device via a viewer link, wherein the presentation is stored on the presentation server;
displaying the view of the presentation on a display of the mobile computing device;
detecting a user input from the mobile computing device; and
controlling the view of the presentation in response to the user input.

26. The method of claim 25, wherein the display is a touch-sensitive screen, and wherein the user input is performed using the touch-sensitive screen.

27. The method of claim 26, wherein a first action of the user input is to request a view of a previous slide of the presentation, and a second action of the user input is to request a view of a next slide of the presentation.

28. The method of claim 27, wherein the first action is a swiping gesture substantially from left to right along a horizontal axis of the mobile computing device, and the second action is a swiping gesture substantially from right to left along the horizontal axis.

29. The method of claim 25, wherein the view of the presentation is automatically provided within a browser of the viewer device accessing the viewer link.

30. The method of claim 25, further comprising:
receiving from the user a selection of the presentation from a plurality of presentations associated with the user and stored on the presentation server.

31. The method of claim 30, further comprising:
receiving from the user a selection of a slide from the presentation, wherein the view of the presentation starts with the selected slide.

32. The method of claim 25, wherein the mobile computing device is a mobile phone.

33. The method of claim 32, wherein the user input is performed using one or more actuatable buttons on the mobile phone.

34. A system for controlling a presentation accessed via a presentation server, the system comprising:
means for providing authentication information from a user of the system to the presentation server;
means for causing the presentation server to provide a view of a presentation to a viewer device via a viewer link, wherein the presentation is stored on the presentation server;
means for providing a remote control interface for the user to enter a user input, wherein the remote control interface is to occupy a display of system; and
means for controlling the view of the presentation in response to the user input.

35. A system for controlling a presentation accessed via a presentation server, the system comprising:
means for providing authentication information from a user of the system to the presentation server;
means for causing the presentation server to provide a view of a presentation to a viewer device via a viewer link, wherein the presentation is stored on the presentation server;
means for displaying the view of the presentation on a display of the system;
means for detecting a user input from the system; and
means for controlling the view of the presentation in response to the user input.
